(19) United States
(12) Patent Application Publication
(10) Pub. No.: US 2024/0152635 A1
(43) Pub. Date: May 9, 2024

(54) SYSTEMS AND METHODS FOR USE IN SECURING OPEN SERVICE CONNECTIONS

(71) Applicant: MASTERCARD INTERNATIONAL INCORPORATED, Purchase, NY (US)

(72) Inventors: Przemek Praszczalek, Cypress, TX (US); Farzana Chilwan, New York, NY (US)

(21) Appl. No.: 18/388,149

(22) Filed: Nov. 8, 2023

Related U.S. Application Data
(60) Provisional application No. 63/424,113, filed on Nov. 9, 2022.

(51) Int. Cl. G06F 21/60

(52) U.S. Cl. CPC G06F 21/606

(57) ABSTRACT

Systems and methods are provided for use in securing open service connections. One example computer-implemented method includes initiating communication between a user and an account host as part of a request for an open service connection by the user, whereby the user provides login credentials to the account host for an account issued by the account host to the user. In response to the request, the method includes receiving access tokens for the open service connection from the account host and identifying data for the user and/or the account. The method also includes performing an assessment of the open service connection based on the identifying data, wherein the assessment is based on current and prior usage of the identifying data, and returning the access token and a result of the assessment to the open service customer.

### CROSS-REFERENCE TO RELATED APPLICATION

This application claims the benefit of, and priority to, U.S. Provisional Application No. 63/424,113, filed Nov. 9, 2022. The entire disclosure of the above application is incorporated herein by reference.

### FIELD

The present disclosure generally relates to systems and methods for securing open service connections, and in particular, to systems and methods for use in assessing open service connections and/or traffic therethrough.

### BACKGROUND

This section provides background information related to the present disclosure which is not necessarily prior art.

It is known for entities to provide for open services, whereby access to the data and/or services is more readily available to other entities. One example of an open service is open banking and/or open finance, whereby user-permissioned financial and non-financial data is shared between banks and third-party service providers, and even the users (consumers) whom the data describes. As such, consumers (e.g., end users, etc.) to whom bank accounts are issued (e.g., the individuals or entities to whom/which the bank accounts belong, etc.), as part of open banking, are enabled to manage their financial data across different platforms.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in securing open service connections;

FIG. 2 is a diagram of example interactions among different data attributes of (or for) a user, including example identity data elements, as may be implemented and/or used in the system of FIG. 1;

FIG. 3 is a block diagram of an example computing device that may be used in the system of FIG. 1;

FIG. 4 includes a flow diagram of an example method, which may be implemented in connection with the system of FIG. 1, for use in securing open service connections;

FIG. 5 includes a flow diagram of another example method, which may be implemented in connection with the system of FIG. 1, for use in securing open service connections; and

FIG. 6 includes an example aggregates the assessment as may be utilized in the system of FIG. 1 and/or the method of FIG. 4 and/or the method of FIG. 5.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Open services, such as, for example, open banking, etc., provide for wider access to data (e.g., name, address, phone number, email address, account balance, transaction history, services utilized, etc.) stored by different institutions. Open banking, in particular, provides for the user-permissioned sharing of such data with other financial institutions or service providers. The access/sharing is based, in some examples, on the use of login credentials specific to a user and associated with the financial institution. Beyond knowledge of the login credentials, and potentially other data (including multi-factor authentication, etc.) presented to an open service customer (e.g., via a financial technology application (e.g., Mint, Rocket Mortgage, etc.), etc.), it may be up to the open service customer or the financial institution independently to assess fraudulent, unauthorized access, etc. using the open service and/or to identify ‘good’ vs ‘bad’ actors. The limited view of either party, or the lack of specific restrictions, potentially expose open services, for example, for purposes of financial transactions, to instances of such unauthorized access, improper activity, and fraud, etc.

Uniquely, the systems and methods herein provide for securing open service connections and/or assessing open service connections and/or traffic therethrough. In particular, an open service provider leverages different data attributes and signals (actual and/or derived), including identity data elements, associated with an open service connection (e.g., to set up the connection, or receive data through the connection, etc.) in order to assess the potential for fraud and/or level of exposure associated with the connection. The assessment may be based on different patterns of data, parameters of the open service traffic (e.g., associated with an account, customer, etc.), etc. In turn, the open service provider, or potentially, an open service customer or account host involved in the open service, is/are notified of the assessment and permitted to take action based thereon. In this manner, data security is imposed on and/or provided in connection with the open service access, whereby fraudulent, unauthorized connections and/or traffic may be reduced, limited or eliminated.

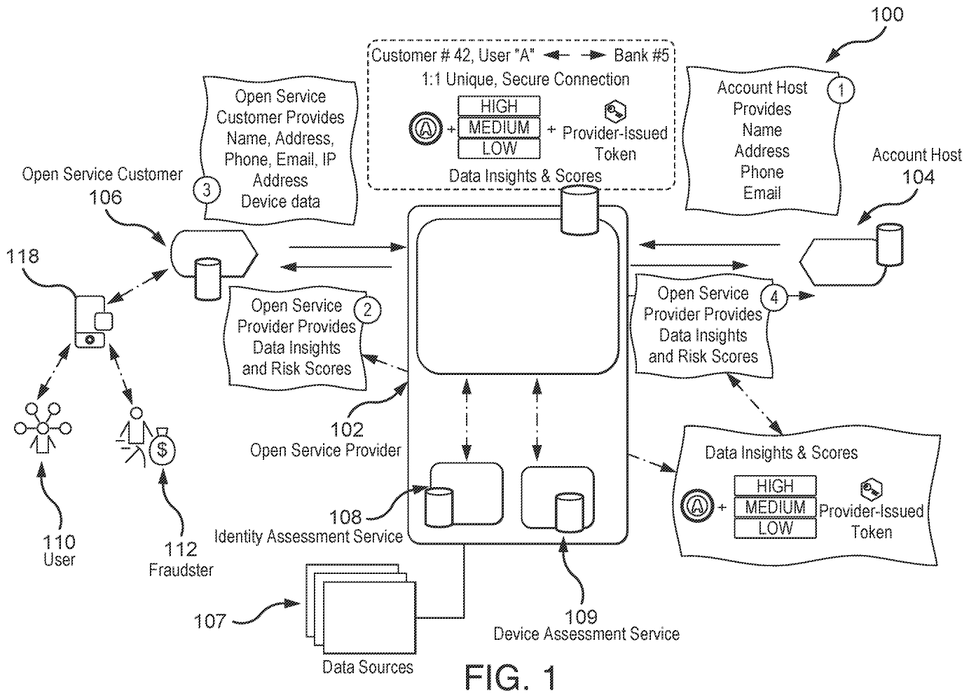

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships, types of users/institutions/customers, open service types, privacy regulations and/or requirements, etc.

The system 100 generally includes an open service provider 102, an account host 104, and an open service customer 106, each of which is coupled to (and is in communication with) one or more networks. The network(s) is/are indicated generally by arrowed lines in FIG. 1, and may each include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The open service provider 102 is configured as a provider, offeror, and/or host of one or more open services, which may be used to share, exchange, and/or access data among one or multiple parties, institutions, etc. In this example embodiment, the open service includes an open banking service, through which, financial data is accessed and/or shared. The open banking service may include one or more application programming interfaces (APIs) exposed by the open service provider 102. The open service provider 102 may include, for example, without limitation, FINICITY/AIIA open banking service, offered by MASTERCARD payment network, etc. The open banking service may be different in other system embodiments, and further, the open service in general may be a service related to or unrelated to banking or financials in other embodiments (e.g., whether open or not, etc.). To this point, it should be appreciated that the present disclosure is not limited to open banking services, but is applicable to open services in general. In other words, the present disclosure is applicable in connection with services connecting or linking two (or more) accounts whereby, as described herein, a risk associated with each end point may be evaluated to provide, for instance, an identity resolution service (if needed), and arrive at data insights as well as security recommendations for the given (unique) 1:1 connection, or even 1:n connections.

It should be understood, however, that, in this example embodiment, the open service provider 102 is configured to collect data related to establishing and/or maintaining open connections, to perform analysis on the collected data (and/or related feedback), to enrich the data (e.g., based on collection of data from multiple hosts/sources, etc.), to impose rules for the open connections, and/or to provide one or more recommendations in association with the open connections, as explained further below. In this manner, the open service provider 102 is configured to provide life-cycle management of the open service(s).

In various example embodiments (and without limitation), the account host 104 is generally a financial institution or a financial services provider, such as, for example, a bank, etc. More generally, the account host 104 is configured to issue accounts to users, which may include financial accounts (e.g., checking accounts, savings accounts, credit accounts, etc.) as well as other accounts like life/auto/home insurance accounts, brokerage accounts, mortgage accounts, as well as accounts relating to non-financial services (e.g., telecommunication accounts, membership accounts, recurring service accounts, etc.), etc., whereby the accounts are associated with and/or hold funds to be used or distributed on behalf of a user to which the account is issued. Again, while the description herein is provided in terms of the account host 104 being a bank or financial institution, the account host 104 may be otherwise in other example embodiments (whereby, as just described, the account host 104 may issue other than financial accounts to users, etc.).

In the illustrated embodiment, the account host 104 is configured to issue a bank (or a financial services) account to a user 110. The account, then, is associated with various data including, for example, personal identifying data about the user 110, or other data. In one particular example, the account may be associated with data including, for example, and without limitation, a name, an address, an email, a phone number, an account number, government issued identifiers (e.g., social security number, driver's license number, passport number, etc.), gender, height, weight, a place of birth, a date of birth, biometrics, etc. It should be appreciated that the user 110 interacts virtually (e.g., electronically, etc.) with the account host 104, regularly or occasionally, whereby the account host 104 may be configured to further collect data associated with the user 110, such as, for example, device identifiers (e.g., a MAC address, an electronic serial number (ESN), an IP address, etc.) (e.g., of communication device 118, etc.), as well as other suitable data. The account host 104 is configured to define additional data for the user 110 as well. For example, when the account is issued to the user 110, an account number, expiration date, etc., for the account is associated with the account and the user 110 as identifying data (or user data). In addition, the user 110 may define login credentials, such as, for example, username, password, etc. (broadly, data herein that may be used to identify the user and/or the user's account), which may be used to access the account host 104 (and the use's account issued by the account host 104), via a website, network-enabled application, etc. The account host 104 is configured to store the data in memory associated with the account host 104.

In one or more embodiments, the account host 104 may be configured to issue non-financial accounts (e.g., a service account, a medical record account, etc.), which are accessible in the same manner and/or associated with similar identifying data to be accessed, shared, etc.

With continued reference to FIG. 1, the open service customer 106 is configured to coordinate one or more services for a service user thereof, via the open service platform described herein. In this example embodiment, the open service customer 106 is configured to provide financial services to the service user, such as, for example, mortgage services, merchant services, account services, fund transfer services, banking services, investment services, or other suitable services, which may require and/or rely on financial data related to a user, etc. In connection therewith, the open service customer 106 is configured to leverage the open service (e.g., to create a connection or channel, etc.) to capture and/or retrieve identifying data about the user, and in particular, financial data about the user, as described in more detail below. In some example embodiments, the open service customer 106 may be included as (or may be part of or may be the same entity as) the open service provider 102, whereby the open service provider and open service customer may be the same entity and whereby such entity is configured as described herein to perform as both the open service provider 102 and the open service customer 106.

As shown in FIG. 1, the system 100 also includes one or more data sources, which are indicated by reference 107. The data sources 107 may include third parties to the open service provider 102, including, for example, government agencies, processing networks, service providers (e.g., insurance, banking, etc.), external sources to aid validation of open service data/connections, fraud/trust networks and consortia, etc. In one example, the data source(s) 107 may include a payment processing network, such as, for example, the MASTERCARD, VISA, AMEX, etc., networks, etc., through which ISO messages and other data packets are exchanged and accessible as data consistent with the above. The payment processing network may additionally or alternatively include ACH payment messaging, real time payment messaging (e.g., ISO 20022, etc.), or other suitable messaging, etc. In at least one example, the data source(s) 107 may be consistent with the account host 104, whereby access to data is consistent with the description herein.

In this example embodiment, the open service provider 102 may be configured to access and/or collect data from the data source(s) 107, as needed or desired, in connection with the operations/steps describe below.

In this example embodiment, the system 100 further includes an identity assessment service 108 and a device assessment service 109 (e.g., as part of the open service provider 102, etc.). It should be appreciated that other services may be included in the open service provider 102 in other system embodiments.

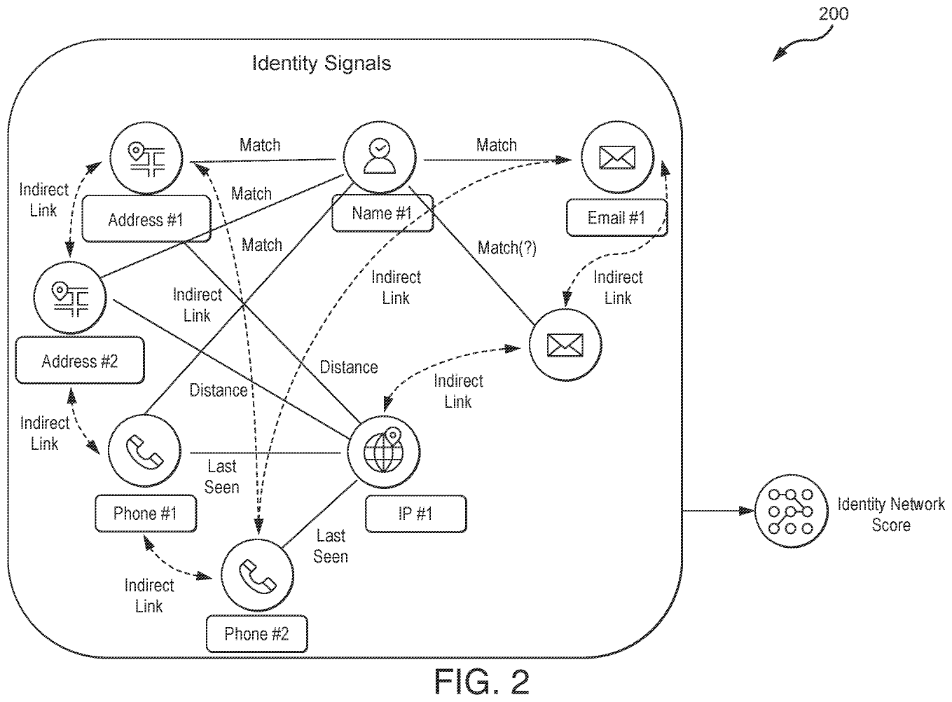

The identity assessment service 108 includes a data structure of user interactions, which includes various user attributes and/or derived data signals (e.g., a name, an address, a phone numbers, emails, device identifiers, etc.) and relatedness of the attributes as part of the particular interactions. For example, Name #1 may be used with phone number #1 and address #1 in one interaction, and then, Name #1 may be used with address #2 and email #1 in another interaction. The data structure may include thousands, or hundreds of thousands, or millions, or more or less, etc., data attributes (e.g., identity attributes or identity data elements, etc.), metadata, and connections (or links) therebetween, thereby providing an expansive indication of identity attribute relatedness across multiple different user profiles, account hosts, providers, and customers, etc. (e.g., the open service provider 102, the account host 104, the customer 106, and hundreds or more other similar entities, etc.). FIG. 2 illustrates an example diagram 200 for a single user profile, which includes identity attributes (broadly, data attributes) and the historical links or relatedness therebetween. It should be appreciated that other diagrams may include various additional profiles and/or attributes and links therebetween in other examples. By leveraging the same, the identity assessment service 108 may be configured: to aid in resolution of the identifying data required to verify that the user is an actual owner of the account issued by the account host 104; to match identifying data to that of the user of the customer 106; to provide dynamic and/or static matching or partial matching of identifying data; and/or to discover any pre-existing, unknown connections between the user's identity elements; etc.

More generally, in this example embodiment, the identity assessment service 108 is configured to assess the identity attributes associated with a request associated with open service(s), based on, for example, one or more identity attributes and/or historical links therebetween, etc., and to return the assessment to the open service provider 102 or other parties involved in the open service(s), as explained more below.

The device assessment service 109 includes a data structure, which includes data specific to devices, such as, for example, IP addresses, MAC address, electronic serial numbers (ESNs), etc., which are connected to one or more identity attributes. The device assessment service 109, like the identity assessment service 108, is configured to assess the device attribute(s) for a request associated with open service(s) and to return the assessment to the open service provider 102 or other parties involved in the open service(s), as explained more below.

While the identity assessment service 108 and the device assessment service 109 are illustrated as separate in FIG. 1, it should be appreciated that the services may be combined into a single service in some example embodiments. What's more, the services 108, 109 may be separate from the open service provider 102 in some example embodiments, or, as indicated by the block diagram in the illustrated embodiment of FIG. 1, the services 108, 109 may be included (in whole or in part) in and/or with the open service provider 102 as part of one or more entities (e.g., the MASTERCARD payment network, etc.).

In addition, in FIG. 1, the system 100 includes the user 110, which is a rightful and correct person to which the account host 104 issued the account. Also, as shown, the system 100 includes a fraudster 112, which is different than the user 110, and who is not a rightful or correct user as it relates to the account issued to the user 110. That said, in the following example, the fraudster 112, in the system 100, is assumed to have possession of the account login credentials for the user 110 at the account host 104, whereby the fraudster 112 attempts to leverage the login credential to commit fraud, or fraudster 112 is able to obtain control over the account and/or the open service connection itself. In either case, it may initially be unclear (or unknown) to the account host 104 and/or open service customer 106 if the user 110 or the fraudster 112 is requesting the open service connection, participating in the open service connection, or otherwise interacting with the open service (e.g., open banking service, etc.) before an open connection (e.g., open banking connection, etc.) is established.

In this example embodiment, the open service provider 102 is configured to enable the establishment of connections between the open service customer 106 and a specific account at the account host 104 (e.g., to connect to an external account, etc.), on behalf of the user 110, as described more below. Then, once established, the open service provider 102 is configured to host traffic between the open service customer 106 and the account host 104, through the connection. It should be appreciated that the initiation of a connection, or traffic through the connection, may be from the user 110 whereby the connection/traffic is authorized, or it may be from the fraudster 112, whereby the connection/traffic is unauthorized. Given the potential presence/activity of the fraudster 112 as initiating the request, the open service provider 102 is configured herein to assess the connection and/or traffic. It should be appreciated that assessments of connections and/or traffic may be executed at any point in time, for example, at (or upon) establishment of new open service connections as described above, as part of regular monitoring of existing open service connections, in connection with assignment of risk levels or levels of assurance associated with the open service connections based on changes in data profiles/metadata of either one or both parties to an open service connection, in connection with multiple connections/parties, etc. In addition, assessments of connections and/or traffic may also (or alternatively) be carried out when renewing/refreshing an open service connection, for example, resulting in changes to the assigned level of assurance. Further, assessments of connections and/or traffic may be carried out for open service connections intended for (or directed to) execution of specific activities considered more risky than others (e.g., initiating a real-time payment vis-à-vis accessing history of financial transactions, etc.).

In particular, the fraudster 112 may request, via communication device 118, a new connection between a service of the open service customer 106 (e.g., account origination, mortgage service, etc.) and the account of the account host 104, via an open service, and in particular, the open banking service. To initiate the request for the connection, the fraudster 112 provides the login credentials for the user 110 (e.g., via a browser or application, etc. at the communication device 118; etc.), which is/are known to the fraudster 112 through one of more schemes, to the open service customer 106. The open service customer 106, in turn, is configured to submit the request for the connection to the open service provider 102, with the request including the login credentials of the user 110. In connection therewith, it should be appreciated that the open service customer 106 may be configured to collect identifying data from the fraudster 112, such as, for example, name, address, email, phone number, or any other data (e.g., actual data, derived data or signals, metadata, etc.) (e.g., any data that may be accessible, used, provided, etc. in connection with the secure connections described herein, etc.), etc. in connection with receiving the request.

While reference is made to the fraudster 112 in this description of the configurations of the open service customer 106, the open service provider 102, and the account host 104, it should be appreciated that these parts of the system 100 are configured the same if the above is initiated by the user 110. Because the open service provider 102 is not informed whether the user 110 or the fraudster 112 is initiating the service, the open service provider 102 is configured to assess each request in a similar manner. That said, such request may include, but is not limited to: account creation/digital onboarding at the open service customer 106, part of the process of establishing an existing open connection between the open service customer 106 and the account host 104, accessing such existing open connection, etc. In connection therewith, an example objective of the service and the value of enabling bi-directional data exchange is to assess the connection and associated risks of the action on each end of the connection being serviced/supported by the open service provider 102.

What's more, while in the above the fraudster 112 is described as using the communication device 118 to initiate the request, it should be appreciated that the user 110 may similarly use a communication device to do the same (whereby, in such instances, the communication device 118 illustrated in FIG. 1 may then represent the user's communication device).

That said, in this example, the open banking service is coordinated through an access token. For instance, the user 110 (or the fraudster 112 when acting nefariously) may identify the account host 104 and desire to access the account at the account host 104. In doing so, the open service provider 102 is configured to facilitate submission of a request for a secure open service connection (established by the user 110 (or the fraudster 112) with proper login credentials utilized by user 110 (or by the fraudster 112 without authorization by the user 110) directly with the account host 104 via the account host's secure channel) to the account host 104, where the request includes a request to issue an access token for the new connection (such that the connection is then associated with the token). The account host 104, in turn, is configured to confirm the login credentials and, when confirmed, to generate the access token, sign the access token and provide the access token and certain identifying data back to the open service provider 102. The identifying data may include name, address, phone number, email address, or any other data (e.g., actual data, derived data or signals, metadata, etc.) (e.g., any data that may be accessible, used, provided, etc. in connection with the secure connections described herein, etc.), etc., which is associated with the account matching the login credentials, as indicated at the “1” in FIG. 1.

In response, the open service provider 102 is configured to assess the connection based on the identifying data, and other details associated with the request for the new connection. For example, the open service provider 102 may be configured to request an assessment of the identity data/signals from the identity assessment service 108, or assessment of the communication device 118 from the device assessment service 109 (e.g., when an ESN, IP address, etc. is provided, which may be identified in the request by the open service customer 106; etc.). In addition, the open service provider 102 may be configured to assess any patterns, frequencies, etc., associated with the request for new connection. For example, the request for the new connection may be duplicative of many other similar requests from the same or other open service customers, or for the same account at the account host 104, whereby a number of such requests and/or a rate of such requests may be assessed and/or an indicator of an issue. Table 1 illustrates a compilation of potential insights/assessments to be employed based on the data available to the open service provider 102.

TABLE 1

Open Service Connection + Processing Network Level info
Historical risk/trust scores over time
Feedback loop from Banks/FIs and open service
customers about the connection
(fraudulent, under investigation, trusted)
Number of attempted connections to Bank/FI
(successful, failed, etc.)
Signals from other payment processing rails
or domains (broadly, data sources 107)
Corresponding payment token information
(assigned to a specific financial account)
Open service customer and/or account level
data found in risk/trust network consortium
History of upgrades/downgrades for open service connection
Number of high value transactions carried out
without financial loss (trust signal)
Velocity, frequency of open service API calls,
user present/not present

The open service provider 102 is configured to compile an assessment (e.g., from the identity assessment service 108, the device assessment service 109, its own assessment, etc.), and to return the assessment and the access token, along with any related insights about the requested connection in this example, as indicated at “2” in FIG. 1, to the open service provider 102 and/or the open service customer 106. Examples of insights may include identity risk scores, validity of individual's data elements, derived data signals about the utilization of various identity data elements, descriptors of relationships between two or more data elements, derived signals from the given activity associated with the connection, frequency of use, geographic location, descriptors of relationships of data elements between two or more identity profiles, etc.

In addition, it should be understood that the open service provider 102 may be further configured to provide the assessment back to the account host 104, as feedback. The assessment may only include labels associated with the insights, or limited data, or may include additional data available to the open service provider 102, etc. In response, the account host 104 may be configured to act based on the assessment (and insights), to, for example, revoke the access token, initiate interaction with the user 110, record data related to the open service request/connection, etc. It should be further appreciated that sharing of the assessment with the open service customer 106 and also to the account host 104 may aid in the management of open service connections, reduction in fraud, and increased levels of trust in the open service(s).

With continued reference to FIG. 1, the open service customer 106 (upon receipt of the assessment and/or insights) is then configured to decide to permit the new connection to the account, or not, based on the assessment (and insights). It should be appreciated that the open service customer 106 may be configured to employ a number of rules to rely on the assessment in determining whether to permit the connection and/or introduce alternate workflows relevant to a given use case. Ultimately, when permitted, the open service customer 106 is configured to store the access token and then, later, to use the access token for subsequent interactions with the account host 104, via the existing connection. When permitted or not permitted, the open service customer 106 is configured to provide a message consistent with the resolution to the communication device 118, which is in turn displayed to the user 110 or fraudster 112. In addition, the open service provider 102 may also be configured to store the access token and then, later, to use the access token for subsequent interactions with the account host 104, via the existing connection.

It should be appreciated that, consistent with the above, the open service provider 102 may also (or alternatively) be configured to decide to permit the new connection to the account, or not, based on the assessment (and insights) (e.g., instead of the new connection being permitted by the open service customer 106, or in conjunction with the decision by the open service customer 106, etc.). In addition, it should be appreciated that the interactions by and between the open service customer 106, the open service provider 102, the account host 104, and, as required, the identity assessment service 108 and the device assessment service 109 may be transparent or not visible to the user 110 or fraudster 112, at the communication device 118. It should also be appreciated that sharing of identifying information and assessment of a new connection, or traffic through an established connection, may be otherwise in other system embodiment.

In this example embodiment, when the open service customer 106 requests a new connection, or data through an existing connection (e.g., as part of the request by the fraudster 112, etc.), the open service customer 106 may also include identifying data collected from the user making the request (e.g., from the fraudster 112, from the user 110, etc.), such as, without limitation, a name, address, phone number, email, device data (e.g., IP address, ESN, etc.), etc., or any other data either obtained from the user 110/fraudster 112, the user's account, and/or the session information, in the request to the open service provider 102. This data is referenced at “3” in FIG. 1. The identifying data may be provided to the open service provider 102 together with the request, or it may be provided subsequent thereto (or prior thereto). Consequently, prior to interacting with the account host 104, or potentially, after receiving identifying data from the account host 104 (at “1”), as explained above, the open service provider 102 may be configured to assess the request/connection based on the identifying data received from the open service customer 106 (i.e., source identifying data) and also the identifying data received from the account host 104, if available. The open service provider 102 may be configured, in assessing the request/connection, for example, to compare the identifying data from the two sources (e.g., names, emails, phone numbers, etc.), assess any traffic patterns related to the open service customer 106 and/or the account, and further to provide the identifying data from either or both of the account host 104 and the open service customer 106 to the identity assessment service 108 and/or the device assessment service 109, which, respectively, are configured to assess the data (e.g., relative to one of more identity attribute diagrams, maps, networks (e.g., as shown in FIG. 2), etc.) and to return an assessment, score and/or insights related to the same to the open service provider 102.

When the request is related to an existing connection, the open service provider 102 is configured to present the request to the account host 104 along with the access token (as associated with the existing connection). In response, the account host 104 is configured to verify the access token, and then to retrieve the requested data (e.g., account balance, etc.) and to return the data to the open service provider 102, or to take other action as indicated in the request, etc.

In connection with the assessment, the open service provider 102 is configured to compile an assessment (based on its assessment, assessments/scores from the assessment services 108, 109, etc.) and to return the assessment (and potentially, the access token for a new connection or retrieved data for an existing connection), along with any related insights about the requested connection in this example, as indicated at “2” in FIG. 1, to the open service customer 106. The open service customer 106 is configured to then determine whether to permit either the connection, to continue to permit the connection, and/or to deliver data to the communication device 118, or not, based on the data from the open service provider 102. The open service provider 102 may further be configured to provide the assessment, related insights, etc., to the account host 104, as indicated at “4” in FIG. 1, as feedback to the account host 104. The account host 104 may be configured to assess the connection, account, etc., based on the data and/or to store the data for assessment of this and subsequent requests related to the account.

It should be appreciated that the assessment may be stored at either the account host 104, the open service customer 106, or the open service provider 102, or at a combination thereof, in a data structure included therein. In one or more embodiments, the assessment may indicate scoring and/or analysis of the data, as described above, yet be devoid of the data itself, whereby storing the assessment may, in the one or more embodiments, provide for enhanced privacy and/or security associated with the open service, etc.

In addition to the access token and the assessment, the open service provider 102 may be configured to include an open service provider-issued token, which is indicative of the identifying data, the assessment, or data associated therewith (e.g., metadata, etc.), along with a time stamp or indication of when and how the assessment was performed, as well as a possible risk factor, and/or a level of assurance/trust, which helps differentiate and better manage tokens and connections within the open banking ecosystem. The provider-issued token, as shown in FIG. 1, for example, may be disseminated to the account host 104 (as referenced at “4” in FIG. 1) (and/or the open service customer 106, as referenced at “2” in FIG. 1), whereby the assessment, the access token and/or the provider-issued token may be stored in memory thereon. The open service provider 102 may be configured also to store the assessment, the access token and/or the provider-issued token stored in memory thereon. The open service provider 102, the open service customer 106, and/or the account host 104 may be configured to retrieve the assessment for subsequent interactions related to the access token, for example, and to reassess the connection/interaction based on a time stamp of the assessment, or otherwise assess or restrict the connection/interaction based on the same.

In connection with the above, the open-service provider-issued token may be used, for example, to support provision of ‘premium’ services like real-time payments by the account host 104, or facilitate access to data at the account host 104 with less friction (or at any other party to a secure connection), which supports provision of financial and non-financial services to end users. In addition, the open-service provider-issued token may be used by the account host 104 to better manage and differentiate incoming data requests from third parties, both for new and existing open service (including open banking, open finance, etc.) connections. Such categorization of secure connections to the account host 104 may enable the account host 104 to develop better tools to enable greater control over increasingly automated digital traffic via open banking rails.

In some examples, either the open service customer 106 or the account host 104 (or both the open service customer 106 and the account host 104) may have an interest in signals/insights which will help them better assess the likelihood that users are truly connecting to their own accounts, including for the purpose of money movement between two accounts/services which belong to the same user. For the open service customer 106 and/or the account host 104, such insights may help to manage risks associated with external connections to/from a user's given account on either end of the open service (e.g., for open banking, open finance, or account-to-account, or peer-to-peer, etc.) connection, etc.

In addition, in some examples, the system 100 may provide the ability to detect/prevent open service connections where a given user (or open service customer 106 acting on behalf of a given user (e.g., user 110, etc.)) is trying to connect to accounts that do not belong to that user (e.g., where a fraudster is acting, etc.), for the purpose of overstating the true extent of that user's financial capability, or for the purpose of obtaining a line of credit, etc. Upon the return of relevant data elements from the account host 104, and upon comparison of relevant data elements from the open service customer 106, the service (via the system 100) may discover that, for example, only three, two, one or none of the data elements match between the two (or more) accounts. In such a scenario, the open service provider 102 may look to the identity assessment service herein to seek out evidence of connection between the two data profiles related in the global identity network and/or other relevant sources of signals about possible connections between the two data profiles and/or individual data elements associated with each.

Further, in some instances, the user's account at the open service customer 106 may be taken over by a fraudster, who, in turn, may try to connect to an account at the account host 104, which the fraudster is also controlling. In this case, the identity risk profile of the account at account host 104 may be high (if there is a high likelihood that a synthetic/fake identity is associated with that account). In some cases, it may be low (for a real identity profile of someone who is collaborating with a fraudster, or whose account has also been compromised).

However, given that, the fraudster may want to connect multiple ‘compromised’ accounts at the open service customer 106 to a single ‘controlled’ account at the account host 104. In this case, while the identity risk assessment may be low (i.e., there is a high likelihood of a real identity profile), the global identity network activity may indicate multiple uses of that identity profile in a very short period of time, with the same account host 104 (or a customer of this service) and thus generate signals about possible identity theft, account takeover, and/or unauthorized use of someone's identity data elements. In such use cases, the system 100 herein is able to evaluate the risk assessment associated with either account at the open service provide 106, the account host 104, or both.

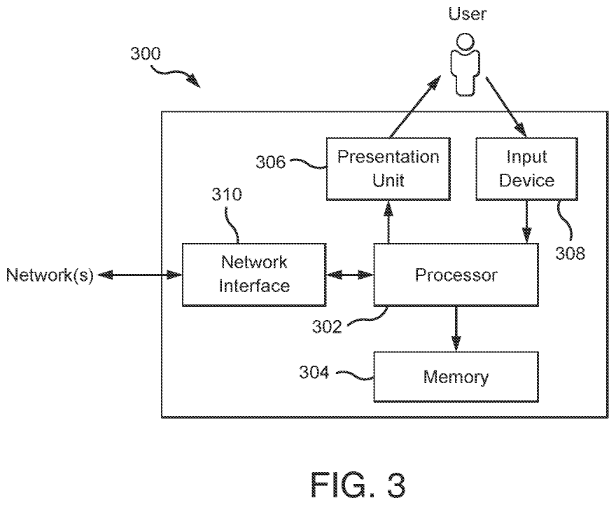

FIG. 3 illustrates an example computing device 300 that can be used in the system 100 of FIG. 1. The computing device 300 may include, for example, one or more servers, workstations, personal computers, laptops, tablets, smartphones, etc. In addition, the computing device 300 may include a single computing device, or it may include multiple computing devices located in close proximity or distributed over a geographic region, so long as the computing devices are specifically configured to function as described herein. In the example embodiment of FIG. 1, the open service provider 102, the account host 104, the open service customer 106, services, 108, 109, and the communication device 118, each may be included in (and/or may include) and/or may each be implemented in a computing device, consistent with and/or similar to the computing device 300, coupled to (and in communication with) one or more networks. However, the system 100 should not be considered to be limited to the computing device 300, as described below, as different computing devices and/or arrangements of computing devices may be used in other embodiments. In addition, different components and/or arrangements of components may be used in other computing devices.

Referring to FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, identity data (e.g., name, address, etc.), device data, access tokens, tokens, and/or other types of data (and/or data structures) suitable for use as described herein. Furthermore, in various embodiments, computer-executable instructions may be stored in the memory 304 for execution by the processor 302 to cause the processor 302 to perform one or more of the operations described herein (e.g., one or more of the operations described in method 400 and/or method 500, etc.), such that the memory 304 is a physical, tangible, and non-transitory computer readable storage media. Such instructions often improve the efficiencies and/or performance of the processor 302 and/or other computer system components configured to perform one or more of the various operations herein, whereby the instructions effectively transform the computing device 300 into a special purpose device configured to perform the unique and specific operations described herein. It should be appreciated that the memory 304 may include a variety of different memories, each implemented in one or more of the operations or processes described herein.

In the example embodiment, the computing device 300 also includes a presentation unit 306 that is coupled to (and is in communication with) the processor 302 (however, it should be appreciated that the computing device 300 could include output devices other than the presentation unit 306, etc.). The presentation unit 306 outputs data, visually or audibly, for example, to a user of the computing device 300 (e.g., the user 110, the fraudster 112, etc.), etc. And, various interfaces (e.g., as defined by one or more websites, applications, etc.) may be displayed at computing device 300, and in particular at presentation unit 306, to display certain information to the user of the device. The presentation unit 306 may include, without limitation, a liquid crystal display (LCD), a light-emitting diode (LED) display, an organic LED (OLED) display, an “electronic ink” display, speakers, etc. In some embodiments, presentation unit 306 may include multiple devices.

In addition, the computing device 300 includes an input device 308 that receives inputs from the user (i.e., user inputs) of the computing device 300 such as, for example, requests for connection of financial data, as further described below. The input device 308 may include a single input device or multiple input devices. The input device 308 is coupled to (and is in communication with) the processor 302 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 306 and an input device 308.

Further, the illustrated computing device 300 also includes a network interface 310 coupled to (and in communication with) the processor 302 and the memory 304. The network interface 310 may include, without limitation, a wired network adapter, a wireless network adapter, or other device capable of communicating to one or more different ones of the networks herein and/or with other devices described herein. In some example embodiments, the computing device 300 may include at least one processor (e.g., the processor 302, etc.), at least one memory (e.g., the memory 304, etc.), and/or one or more network interfaces (e.g., network interface 310, etc.) included in, or incorporated into or with the at least one processor.

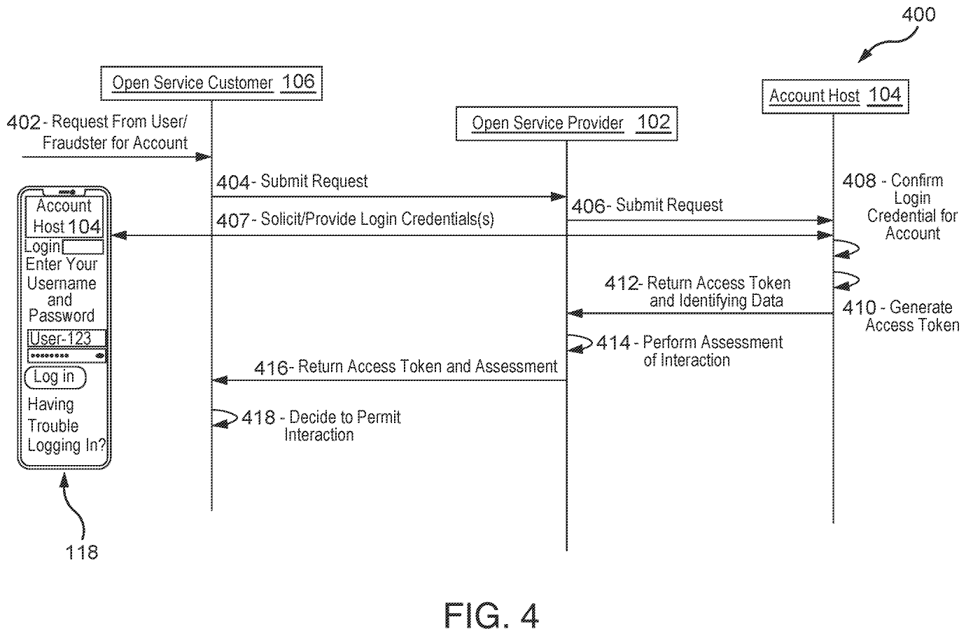

FIG. 4 illustrates an example method 400 for use in securing open service connections. The example method 400 is described as implemented in the open service provider 102, the account host 104 and the open service customer 106 of the system 100. And, reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 400.

At the outset, at 402, one of the user 110 and the fraudster 112 submits a request (e.g., a request for a connection, or activation of an existing connection, etc.), from the communication device 118, to the open service customer 106. It is not clear, initially at least, to the open service customer 106, which user is submitting the request, whereby an assessment is performed as described herein.

Given that, in response to the request, the open service customer 106 compiles the request and facilities, at 404, the request with the open service provider 102. The request includes the need to facilitate direct authentication by user with the login credentials for the account at the account host 104 (e.g., via the user's username, password, etc.), and also various other data related to the connection, such as, for example, an identifier of the open service customer 106, account identifier for the account at the account host 104 (e.g., routing number, account number, etc.), account host identifier, connection details, etc. It should be appreciated that other or different data may be included in the request, as described below. In various examples, it should be appreciated that the request does not include the user's login credentials for the user's account at the account host 104.

Upon receipt of the request, the open service provider 102 facilitates, at 406, direct authentication by the user with the login credentials to the account host 104 as part of a request to establish a connection with the associated account. For instance, as shown in FIG. 4, the open service provider 102 may facilitate a direct connection between the account host 104 and the user's communication device 118, at 407, whereby the user communicates directly with the account host 104 via the account host's secure channel. Such connection may be via a lightbox, via an interface associated with an application at the communication device, via a website associated with the account host 104 (e.g., as accessed at the communication device via a browser thereon, etc.), etc. The open service provider 102 in general may also identify the open service customer 106 and provide additional data to the account host 104 related to the requested connection. The additional data may be required by the account host 104, or associated with an open service standard, or in this example, an open banking standard, etc.

Initially, in response to the user providing the login credentials to the account host 104, the account host 104 confirms, at 408, the login credentials for the specific account. This may include, for example, identifying the account based on a username (or email, or other identifier(s)) and then verifying that the password from the login credentials, for example, matches the password for the account known to the account host 104 (e.g., as stored in memory). Other forms of confirmation may include interaction with the user 110 (or the fraudster 112), via a one-time-passcode (OTP), password-less authentication, or other suitable confirmation, etc.

Then, after confirmation of the login credentials, the account host 104 generates, at 410, an access token for the account. The access token may include any different type of data, in one or more formats, which is either securely signed or not, which is used for subsequent interactions for the connection to be established between the open service customer 106 and the account host 104. Once generated, the account host 104 returns, at 412, the access token and certain identifying data to the open service provider 102. The identifying data may include, in this example, a name, address, phone number, email, etc., which is included in or part of the account identified in the request and/or is based on the login credentials, etc. In general, the identifying data is specific to the user 110 (and not the fraudster 112 in various use cases, i.e., it is assumed the fraudster did not open the account). At this point, as indicated by the access token, the account host 104 has agreed to permit the connection.

The open service provider 102 receives the access token and the identifying data from the account host 104, and at 414, performs an assessment of the request. The assessment may include various different data related to the present request or other request, different identity attributes, etc.

In one example, the open service provider 102 submits the identifying data to the identity assessment service 108, which performs an assessment of a profile indicated by the identifying data. This may include, without limitation, assessment of prior open banking interactions with the same grouping of names, addresses, phone numbers, and/or emails, IP address, and other relevant data, etc. The assessment may include an assurance level of high, medium or low, which is returned to the open service provider 102.

Additionally, or alternatively, the open service provider 102 may assess the request based on a velocity of requests for the specific account and/or login credentials over a period of time, etc.

Regardless of the particular assessment, at 416, the open servicer provider 102 returns the access token from the account host 104, and the assessment of the request, to the open service customer 106. The assessment may indicated an assurance score and/or level in the request. In one example, as shown in FIG. 1, for example, the assessment includes color indicators: green, yellow, or red as indicators associated with relative levels of assurance (or risk). That said, other indicators, numbers, scores, symbols, etc. may be employed to relay the specific level of assurance (or risk) herein.

Examples of such assessments and insights may include (and/or may relate to) identity risk scores, validity of the individual's data elements, derived data signals about the utilization of various identity data elements, descriptors of relationships between two or more data elements, derived signals from the given activity associated with the connection, frequency of use, geographic location, descriptors of relationships of data elements between two or more identity profiles, etc. Other examples of assessments and insights related to ‘identity resolution’ may include, for example, evidence of past connections between two or more data elements from the respective data profiles at the open service provider 106 and account host 104, as well as details about the timing, frequency, context, location, service details, etc. at the time of such connections and over a short or extended period of time. Use of multiple such examples may help establish indirect connections between two data profiles, thus increasing a likelihood that both accounts on each side of the secure connection may belong to the same user, for example.

That said, a lack of such connections/relationships between data profiles may not necessarily indicate a lack of relationship overall, but can generate a strong signal to support decisioning regarding an open service connection (e.g., an open banking/finance connection, etc.) by the open service customer 106, the open service provider 102, and/or the account host 104. Further, a lack of discovered connections between two data profiles, combined with high risk scores for either of the data profiles, may result in a ‘red’ (low level of assurance) designation by the open service provider 102. Some level of connection between data elements like name/address, but not email/phone number, combined with low to medium identity and network risk scores and insights, may result in a ‘yellow’ (medium level of assurance) designation. Strong evidence of connection/relationship between two data profiles, along with low identity and network scores and insights, may result in a ‘green’ (high level of assurance) designation for a given open service connection. Connections may be upgraded or demoted to a different level of assurance/risk, depending on the changes in the assessments conducted periodically, rule-driven or for given use cases, whether it happens as a result of data/profile changes on either side of a open service connection, the result of changes in utilization patterns for one or both data profiles, or other relevant factors, which influence the assessment outcomes.

It should be further understood that data, assessment, and/or insights indicative of the open connection (e.g., open banking connection, etc.) (e.g., including its status, consent management, data access rights and privileges, minimum security standards met, outcomes of identity risk assessments, etc.), the access token, or any other program, platform, and/or mechanism that supports open connectivity, may further be embedded, presented, and utilized as a verifiable credential (VC), which may be understood to be a standard format for expressing digital claims in a way that is cryptographically secure, privacy-respecting, and machine-verifiable (e.g., through the World Wide Web Consortium (W3C) (at www.w3.org), etc.). The verifiable credentials may then be presented to any stakeholder in an open ecosystem (e.g., the opens service customer 106 or others in system 100, end user, data recipient, data provider, data aggregator, and/or authorized third party, etc.). The verifiable credentials could be issued by stakeholders and appended to the data packet describing the current and/or historical data, assessment, and/or insights of one or more open connections.

With continued reference to FIG. 4, upon receipt of the access token and the assessment, the open service customer 106 decides, at 418, whether to permit the request (e.g., the connection with the account, etc.) to proceed, apply conditions, introduce alternate workflows, and/or provide conditional approval with more limited access to data, etc. When the open service customer 106 decides to proceed, the access token is stored in association with the connection, for example, whereby the opens service customer 106 is permitted to interact, on behalf of the user 110, for example, with the account host 104. When the open service customer 106 decides not to proceed, the request is denied or routed via alternate workflows, which may help to decrease level of risk and increase level of assurance in this open service connection. Regardless of the decision, a message indicative of the decision, and potentially, a notice of further processing, is provided to the user 110 (or the fraudster 112) at the communication device 118. In general, the open service customer is permitted to better manage the new and existing open service connections to the account, including automated data requests.

Despite the assessment being performed after interacting with the account host 104, in this example embodiment, it should be appreciated that the open service provider 102 may perform the assessment upon receipt of the request from the open service customer 106 in other embodiments. What's more, it should be appreciated that in various embodiments, the open service provider 102 may decide to permit the request (e.g., connection, etc.) or not, rather than leaving the decision to the open service customer 106.

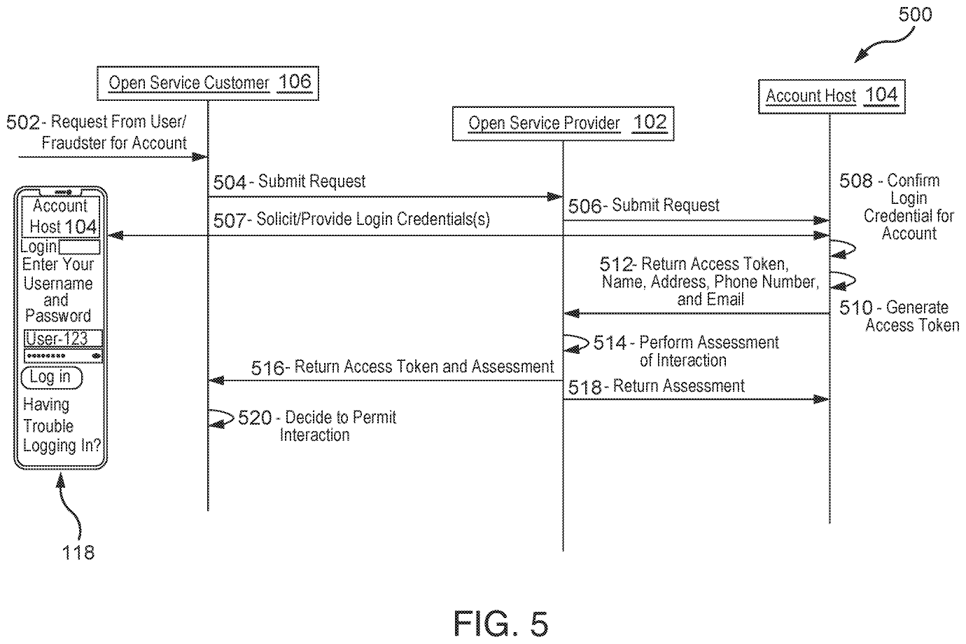

FIG. 5 illustrates an example method 500 for use in securing open service connections. The example method 500 is described as implemented in the open service provider 102, the account host 104 and the open service customer 106 of the system 100. And, reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 500.

At the outset, at 502, one of the user 110 and the fraudster 116 again submits a request, via the communication device 118, to the open service customer 106. It is not clear, initially at least, which user is submitting the request, whereby the assessment is performed as described herein.

Given that, in response to the request, the open service customer 106 compiles the request and facilitates, at 504, the request to the open service provider 102. The request includes the need for direct authentication by user with the login credentials for the account at the account host 104 (e.g., via the user's username, password, etc.), and also various other data related to the connection, such as, for example, an identifier of the open service customer 106, account identifier (e.g., a routing number, account number, etc. for the account at the account host 104), account host identifier, connection details, etc. It could also be a presentation of a valid access token by the open service provider 102, on behalf of the open service customer 106. It should be appreciated that other data may be included in the request, as described below.

In this embodiment, however, the request also includes identifying data related to the one of the user 110 and the fraudster 112 submitting the request, as known or submitted to the open service customer 106. For example, the identifying data may include, without limitation, a name, address, phone number, and/or email of the submitting user, and also one or more device identifiers specific to the communication device 118 (e.g., IP address, MAC address, ESN, etc.). For example, where the fraudster 112 is enrolling with the open service customer 106, the fraudster 116 provides this data to establish an account with the open service customer 106, and then provided the login credentials for the account at the account host 104, to connect that account at the open service customer 106 to access funds or financial data associated with the account at the account host 104, via the open service customer 106. It should be appreciated that other suitable identifying data may be included in the request to the open service provider 102.

Upon receipt of the request, the open service provider 102 facilitates, at 506, the direct authentication by the user with login credentials to the account host 102 as part of a request to establish a connection with the associated account. For instance, as shown in FIG. 4, the open service provider 102 may facilitate a direct connection between the account host 104 and the user's communication device 118, at 507, whereby the user communicates directly with the account host 104 via the account host's secure channel. Such connection may be via a lightbox, via an interface associated with an application at the communication device, via a website associated with the account host 104 (e.g., as accessed at the communication device via a browser thereon, etc.), etc. The open service provider 102 in general may also identify the open service customer 106 and provides additional data to the account host 104 related to the requested connection. The additional data may be required by the account host 104, or associated with an open service standard, or in this example, an open banking standard, etc. That said, it should be appreciated that the open service provider 102 does not see and/or is not made aware of the particular login credentials for the user required to establish the access at the account host 104. Such credentials are directly provided to the account host 104 by the user requesting access (e.g., via a secure connection established between the account host 104 and the communication device 118 in response to the request, etc.).

Consistent with the embodiment of FIG. 4, in response, the account host 102 confirms, at 508, the login credentials provided by the user for the specific account. This may include, for example, identifying the account based on a username (or email, or another identifier) and then verifying that the password from the login credentials matches the password for the account known to the account host 104 (e.g., as stored in memory). Other forms of confirmation may include interaction with the user 110 (or the fraudster 112), via a one-time-passcode (OTP), or other suitable confirmation, etc.

Then, after confirmation of the login credentials, the account host generates, at 510, an access token for the account. The access token may include any different type of data, in one or more formats, which is either securely signed or not, and which is used for subsequent interaction for the connection to be established between the open service customer 106 and the account host 104. Once generated, the account host 104 returns the access token and certain identifying data to the open service provider 102. The identifying data may include, in this example, a name, address, phone number, email, etc., which is included in or part of the account identified in the request and/or based on the login credentials, etc. In general, the identifying data is specific to the user 110 (and not the fraudster 116 in various use cases, i.e., it is assumed the fraudster did not open the account). At this point, as indicated by the access token, the account host 104 has agreed to permit the connection.

The open service provider 102 receives the access token and the identifying data from the account host 102, and at 514, performs an assessment of the request. The assessment may include various different data related to the present request or other request, different identity attributes, etc.

In one example, the open service provider 102 assesses the request based on matching between the identifying data from the account host 102, and the data received, at 504, from the open service customer 106 in an attempt to resolve the identity of the user/fraudster with some level of confidence, as described below (e.g., via the identity assessment service 108, etc.).

In addition, in one or more examples, the open service provider 102 submits the identifying data to the identity assessment service 108, which performs an assessment of a profile indicated by the identifying data. This may include, without limitation, assessment of prior open banking interactions with the same grouping/links of the user's name, address, phone number, and/or email, etc. (see, e.g., FIG. 2, etc.). The assessment may include an assurance identity score, which is returned to the open service provider 102. In still another example, the open service provider 102 submits the device identifier(s) to the device assessment service 109, which performs an assessment of a profile indicated by the specific device, i.e., communication device 118. This may include, without limitation, the use of the communication device 118 with the same name, address, email, phone number, or the use of the communication device 118 in other “good” or “fraud” interaction, via the open service, etc. (see, e.g., FIG. 2, etc.). The assessment may include an assurance device score, which is returned to the open service provider 102.

In one example, the identity assessment service 108 assesses the identifying data from the open service customer 106 (source identifying data) and the identifying data from the account host 104, as provided in Table 2. Table 2 then also includes example forms for responses that may be provided based on the data. Table 3 includes example responses (e.g., based on the example data and response forms of Table 2, etc.) that may indicate a strong link and example responses that may indicated a weak (or no) link, and which are generated by the identity assessment service 108 (based on an identity attribute diagram such as illustrated in FIG. 2). It should be appreciated that the data and responses included in Tables 2 and 3 are example only, and other data may be included and/or used, and/or that other responses may be generated depending on, for example, the identifying data and recognized links there between.

TABLE 2

| Source | Host | |
|---|---|---|
| Identifying | Identifying | |
| Data | Data | Example Responses |
| Name #1 | Name #2 | Phone #1 and E-mail #2-1^{st} seen together, |
| Address #1 | Address #2 | # of times |
| Phone #1 | Phone #2 | Phone #2 and E-mail #1-1^{st} seen together, |
| E-mail #1 | E-mail #2 | # of times |
| IP Address #1 | | Name #1 and Address #2 link |
| | | Name #2 and Address #1 link |
| | | Phone #1 to Address #2 distance |
| | | Phone #2 to Address #1 distance |
| | | Name #1 and E-mail #2 |
| | | Name #2 and E-mail #1 |
| | | IP Address #1 to Address #2 distance |
| | | Validate identity elements for #1 and #2 |

TABLE 3

| Example Strong Link | Example Weak/No Link |
|---|---|
| Phone #1 and E-mail | Phone #1 and E-mail #2 were |
| #2 were 1st seen together | never seen together. |
| 7 years and 124 days ago. | Phone #1 has had multiple |
| They have appeared together | connections to |
| between 5-10 times each calendar | E-mail #1 and Address #1, |
| year, without any significant | and Name #1 over the last |
| spikes in usage/utilization. | 10 years. E-mail #2 has had |
| Phone #1 and E-mail #2 were | multiple connections to |
| seen last 15 days ago. | Phone #2, Address, |
| Phone #1 has had multiple | #2, IP Address #2, and |
| connections to E-mail #1 | Name #2 over the last 10 years. |
| and Address #1, and Name #1 | However, none of the data |
| over the last 10 years. | elements from either of the data |
| E-mail #2 has had multiple | profiles were ever seen together in |
| connections to Phone #2, Address, | the global identity network. |
| #2, IP Address #2, and Name #2 | Use/utilization of data elements |
| over the last 10 years. | from profile #1 reveals |
| Both Phone #2 and E-mail #2 show | significant use of that |
| a strong, consistent link to | data profile over the last 60 days. |
| Address #2 over the last 10 | There are at least 50 different |
| years, while Phone #1 and E- | IP addresses associated |
| mail #1 show a link of over 5 years. | with that account. |

Table 4 includes an example output of an assessment, as may be provided by the open service provider 102 herein. It should be appreciated that a number of possible data combinations for Table 4 increase with the data set size.

TABLE 4
Set size (n) = 9
Subset size (r) = 2
Combination -> ₙCᵣ = n!/r! (n-r)!
Bilateral combination = 36
Possible response involving different data element
types = 32
(excluding combinations between the same data
elements types like Phone #1 and Phone #2 (if needed)

Also, the open service provider 102 may assess the request based on a velocity of requests for the specific account, the open service customer 106, and/or the login credentials over a period of time, etc.

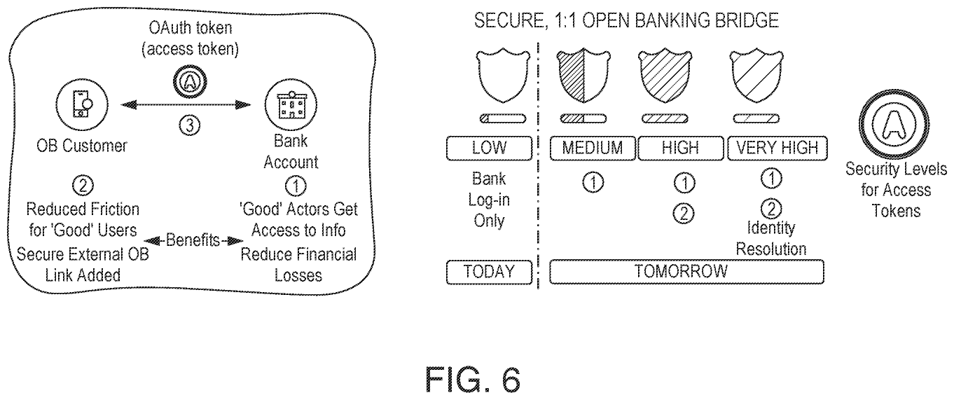

The open service provider 102, as necessary, aggregates the assessment(s), and at 516, returns the access token from the account host 104 and the assessment of the request to the open service customer 106. The aggregated assessment may indicate an assurance score and/or level in the request. In one example, the assessment includes a green, yellow, or red indicator associated with assurance (or risk). One example aggregation is shown in FIG. 6. In connection with performing such an aggregation in this example, at “1”, the risk associated with the account host 104 to which the user/fraudster is connecting is evaluated. At “2”, the risk associated with the user/fraudster creating/invoking the open service connection is evaluated. And, at “3”, a secure 1:1 open service connection is established between the user/fraudster and the account host 104.

In addition to providing the assessment to the open service customer 106, the open service provider 102 also returns, at 518, the assessment to the account host 104. The account host 104 may separately consider the propriety of the request/connection for this particular account and/or compile various assessments over multiple requests/connections to provide a more general assessment of the open service.

With continued reference to FIG. 5, upon receipt of the access token and the assessment, the open service customer 106 decides, at 518, whether to permit the request (e.g., the connection with the account, etc.) to proceed. When the open service customer 106 decides to proceed, the access token is stored in association with the connection, for example, whereby the open service customer 106 is permitted to interact, on behalf of the user 110, for example, with the account host 104.

Despite the assessment being performed after interacting with the account host 102, in this example embodiment, it should be appreciated that the open service provider 102 may perform the assessment upon receipt of the request from the open service customer 106 (e.g., prior to step 506, etc.) in other embodiments, whereby some assessment may be provided to the account host 104 (e.g., at step 506, etc.) to inform any confirmation/validation performed by the account host 104, etc. What's more, it should be appreciated that in various embodiments, the open service provider 102 may decide to permit the request (e.g., connection, etc.) or not, rather than leaving the decision to the open service customer 106.

In connection with the assessment, by the open service provider 102, the assessment may be limited or comprehensive, as explained above, in connection with “pay-by-bank” implementations. For example, in response to a request for a connection from the open service customer 106, the open service provider 102 may retrieve and return identity+device data elements from account host 104 (e.g., name, address, email, and phone number, etc.), or other relevant data signals, for the specific user 110 (or fraudster 112 in other instances).

The open service provider 102 determines, as explained above, the identity assessment and insights for the new open connection to the account host 104. In connection therewith, the open service provider 102 may assess the account host 104 and the specific account at the account host to be connected. Also, the open service provider 102 may assess the account of the open service customer 106 to be connected. The open service provider 102 may provide the assessment to the account host 104 and/or the open service customer 106. The open connection is therefore assessed as to the accounts at both ends. In addition, the open service provider 102 may also match the identity+device data from the account at the account host 104 and the user profile represented by the open service customer 106. The matching may be limited to one or more of the name, address, email and phone number, or may extend to other data elements, etc. The degree of match may be indicated in the assessment, whereby the account host 104 and/or the open service customer 106 is expected to act. Alternatively, the open service provider 102 may seek additional identity resolution and/or trust signals when the degree of matching is below a threshold. In connection therewith, or additionally, the open service provider 102 may search for evidence of connection between the data elements in one or more data sources 107 (e.g., a global identity network, risk consortia, etc.).

Again, the assessment and insight gain from the above may be presented in any number of manners to the account host 104 and the open service customer 106. In this way, a multi-tier protection of the open service connection may be provided based on the investigation of the particular requested connection. That is, the performance of the assessment and/or receipt of the assessment of the accounts, the identity data elements, etc., may be selected and/or requested for specific open connection (e.g., new, continuing, etc.), as desired by the account host 104, the open service customer 106, or potentially, as imposed by the open service provider 102, etc. As such, the multi-tiered assessment defines a flexible approach to securing data associated with open services.

In view of the above, the systems and methods herein provide for secure open service connections, based on, for example, assessing open service connections and/or traffic therethrough. One or more different data attributes and signals (actual and/or derived), including identity data elements and device data elements, may be leveraged to assess the potential exposure associated with the connection. The assessment may be based on different patterns of data, parameters of the open service traffic (e.g., associated with an account, customer, etc.), etc. In turn, an open service provider is able to notify relevant parties of the assessment and permitted to take action based thereon. In this manner, improved and enhanced data security over conventional schemes is imposed in connection with the open service access, whereby unauthorized connections and/or traffic (broadly, access to the specific data) may be reduced, limited or eliminated.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing: (a) in connection with initiating communication between a user and an account host, receiving a request for an open service connection by the user, via an open service customer; (b) submitting, by a computing device, the request to the account host, whereby the user provides login credentials for an account issued by the account host; (c) receiving, by the computing device, an access token for the open service connection from the account host and identifying data for the user and/or the account; (d) performing, by the computing device, an assessment of the open service connection based on the identifying data, wherein the assessment is based on prior usage of the identifying data; and (e) returning the access token and a result of the assessment to the open service customer, thereby permitting the open service customer to facilitate the open service connection to the account.

In connection therewith, the executable instructions, when executed by the processor, may cause the processor, in connection with compiling the assessment, to include the number of the determined one or more attribute commonalties in the assessment, whereby the relying party determines whether or not to further interact with the asserting party in connection with the network request based, at least in part, on the number of the one or more links. And, the executable instructions, when executed by the processor, may cause the processor, in connection with compiling the assessment, to further compare the number of the determined one or more attribute commonalities to a threshold and include the comparison in the assessment, whereby the relying party determines whether or not to further interact with the asserting party in connection with the network request further based, at least in part, on the comparison.

And, the executable instructions, when executed by the processor, may also cause the processor to generate a commonality diagram for the multiple identities included in the memory and the executable instructions, when executed by the processor, may cause the processor, in connection with determining the one or more attribute commonalities, to determine the one or more attribute commonalities based on the commonality diagram; while the executable instructions, when executed by the processor, may also cause the processor to search a deep web for the one or more attribute commonalities, and the executable instructions, when executed by the processor, may cause the processor, in connection with compiling the assessment, to include includes an indicator in the assessment in response to at least one of said one or more attribute commonalities being found on the deep web.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in securing open service connections, the method comprising:
in connection with initiating communication between a user and an account host, receiving a request for an open service connection by the user, via an open service customer;
submitting, by a computing device, the request to the account host, whereby the user provides login credentials for an account issued by the account host;
receiving, by the computing device, an access token for the open service connection from the account host and identifying data for the user and/or the account;
performing, by the computing device, an assessment of the open service connection based on the identifying data, wherein the assessment is based on prior usage of the identifying data; and
returning the access token and a result of the assessment to the open service customer, thereby permitting the open service customer to facilitate the open service connection to the account.

2. The computer-implemented method of claim 1, wherein the open service connection includes an open banking connection; and
wherein the account host includes a financial service provider.

3. The computer-implemented method of claim 1, wherein performing the assessment includes linking, via an identity assessment service, the identifying data to prior interactions including the identifying data.

4. The computer-implemented method of claim 1, wherein the request includes source identifying data; and
wherein performing the assessment of the open service connection includes performing the assessment of the open service connection further based on the source identifying data.

5. The computer-implemented method of claim 4, wherein receiving the access token includes receiving the access token and host identifying data; and
wherein performing the assessment of the open service connection includes performing the assessment of the open service connection further based on the host identifying data.

6. The computer-implemented method of claim 1, further comprising:
storing the assessment and the access token in memory;
retrieving the assessment for a subsequent request via the open service connection between the open service customer and the account host, based on the access token; and
notifying the open service customer and the account host of the assessment.

7. The computer-implemented method of claim 1, wherein the identifying data includes a name, address, email, phone number, IP address, device identifier, and/or metadata.

8. A non-transitory computer-readable storage medium comprising executable instructions for use in securing open service connections, which when executed by at least one processor, cause the at least one processor to perform:
in connection with initiating communication between a user and an account host, receiving a request for an open service connection by the user, via an open service customer;
submitting, by a computing device, the request to the account host, whereby the user provides login credentials for an account issued by the account host;
receiving, by the computing device, an access token for the open service connection from the account host and identifying data for the user and/or the account;
performing, by the computing device, an assessment of the open service connection based on the identifying data, wherein the assessment is based on prior usage of the identifying data; and
returning the access token and a result of the assessment to the open service customer, thereby permitting the open service customer to facilitate the open service connection to the account.

9. The non-transitory computer-readable storage medium of claim 8, wherein the open service connection includes an open banking connection; and
wherein the account host includes a bank and/or financial service provider.

10. The non-transitory computer-readable storage medium of claim 8, wherein the executable instructions, when executed by at least one processor, cause the at least one processor to, in assessing the open service connection, perform: linking, via an identity assessment service, the identifying data to prior interactions including the identifying data.

11. The non-transitory computer-readable storage medium of claim 8, wherein the request includes source identifying data; and
wherein receiving the access token includes receiving the access token and host identifying data; and
wherein assessing the open service connection is further based on the source identifying data and the host identifying data.

12. The non-transitory computer-readable storage medium of claim 11, wherein the identifying data includes a name, address, email, phone number, IP address, device identifier, and/or metadata.

13. A system for use in securing open service connections, the system comprising:
an open source provider computing device, which is configured to:
in connection with initiating communication between a user and an account host, receive a request for an open service connection by the user, via an open service customer;
submit the request to the account host, whereby the user provides login credentials for an account issued by the account host;
receive an access token for the open service connection from the account host and identifying data for the user and/or the account;
perform an assessment of the open service connection based on the identifying data, wherein the assessment is based on prior usage of the identifying data; and
return the access token and a result of the assessment to the open service customer, thereby permitting the open service customer to facilitate the open service connection to the account.

14. The system of claim 13, wherein the open service connection includes an open banking connection; and
wherein the account host includes a bank and/or financial service provider.

15. The system of claim 13, wherein the open source computing device is configured to perform the assessment by linking, via an identity assessment service, the identifying data to prior interactions including the identifying data.

16. The system of claim 13, wherein the open source computing device is configured, by an identity assessment service, to perform the assessment based on multiple user attributes included in the identifying data; and
wherein the open source computing device is configured, by a device assessment service, to perform the assessment based on at least one device attribute associated with a computing device submitting the request.

17. The system of claim 13, wherein the request includes source identifying data; and
wherein the open source computing device is configured to perform the assessment further based on the source identifying data.

18. The system of claim 17, wherein receiving the access token includes receiving the access token and host identifying data; and
wherein the open source computing device is configured to perform further based on the host identifying data.

19. The system of claim 13, wherein the computing device is further configured to:
store the assessment and/or the access token in memory;
retrieve the assessment for a subsequent request via the open service connection between the open service customer and the account host, based on the access token; and
notify the open service customer and the account host of the assessment.

20. The system of claim 13, wherein the identifying data includes a name, address, email, phone number, IP address, device identifier, and/or metadata.
